(19) United States
(12) Patent Application Publication
(10) Pub. No.: US 2015/0008875 A1
(43) Pub. Date: Jan. 8, 2015

(54) WIRELESS CHARGING HOLDER AND ASSEMBLY OF ELECTRONIC DEVICE AND WIRELESS CHARGING HOLDER

(71) Applicant: ASKEY COMPUTER CORP., NEW TAIPEI CITY (TW)

(72) Inventors: Chien-Hao Huang, New Taipei City (TW); Chiu-Ming Ho, New Taipei City (TW)

(73) Assignee: ASKEY COMPUTER CORP., NEW TAIPEI CITY (TW)

(21) Appl. No.: 14/065,442

(22) Filed: Oct. 29, 2013

(30) Foreign Application Priority Data
Jul. 5, 2013 (TW) 102124207

(51) Int. Cl. H02J 7/00; H02J 7/02

(52) U.S. Cl. CPC H02J 7/0042; H02J 7/025
USPC 320/108

(57) ABSTRACT

A wireless charging holder and an assembly of an electronic device and the wireless charging holder are provided. The wireless charging holder includes a body, a fixing element, a power line, a first coil, and a first magnetic element. The body is used to hold the electronic device. The fixing element has a first end connecting with the body and a second end fixed on a vehicle. The power line has a third end connecting with the body and a fourth end to plug into a socket. The first coil on the body is electronically connected with the power line. The first magnetic element disposed in the body is adjacent to the first coil. The electronic device having a second coil is fixed by the first magnetic element on the body, and the first coil overlaps the second coil to induce current for charging the electronic device.

### CROSS-REFERENCE TO RELATED APPLICATION

This application claims the priority benefit of Taiwan application serial no. 102124207, filed on Jul. 5, 2013. The entirety of the above-mentioned patent application is hereby incorporated by reference herein and made a part of this specification.

### BACKGROUND OF THE INVENTION

1. Field of the Invention

The invention relates to a wireless charging holder having charging function, and more particularly, to the wireless charging holder and an assembly of the wireless charging holder and an electronic device using the wireless charging holder.

2. Description of Related Art

As technology advances, electronic products such as mobile phones and satellite navigators have become common electronic products used when driving. To allow the user to use these electronic products when traveling in a vehicle, a variety of holders for holding electronic devices have manufactured and sold on the market.

FIG. 1 is a schematic diagram of a conventional holder. Referring to FIG. 1, although the current holder 100 has ears 110 that can bilaterally hold the electronic device, when the electronic device is mounted on the holder 100, a guide rail may first need to be installed on the electronic device to facilitate mounting. Moreover, the fixture is in contact with the electronic device and therefore may scratch the exterior of the electronic device.

### SUMMARY OF THE INVENTION

The invention provides a wireless charging holder having wireless charging function.

The invention further provides an assembly of an electronic device and a wireless charging holder, wherein when the electronic device is mounted on the wireless charging holder, the electronic device can be wireless charged.

The wireless charging holder of the invention is suitable for installing on a vehicle and the electronic device is suitable for placing on the wireless charging holder for charging. The wireless charging holder includes a body, a fixing element, a power line, a coil, and a first magnetic element. The body is suitable for holding the electronic device. The fixing element has a first end and a second end, wherein the first end is connected with the body and the second end is fixed on the vehicle. The power line has a third end and a fourth end, wherein the third end is connected with the body and the fourth end is suitable for plugging into an external socket. The coil is disposed on the body and electronically connected with the power line. The first magnetic element is disposed in the body and adjacent to the coil to magnetically attach the electronic device.

In an embodiment of the wireless charging holder of the invention, the coil is disposed in the body or disposed on the surface of the body.

In an embodiment of the wireless charging holder of the invention, the fixing element is a suction attachment or a suction cup.

In an embodiment of the wireless charging holder of the invention, the first magnetic element is at the center of the coil, at four sides on the inside of the coil, at four sides on the outside of the coil, or a combination thereof.

The wireless charging holder in the assembly of an electronic device and a wireless charging holder of the invention is suitable for installing on a vehicle, and the wireless charging holder includes a body, a fixing element, a power line, a first coil, and a first magnetic element. The body is suitable for holding the electronic device and the fixing element has a first end and a second end, wherein the first end is connected with the body and the second end is fixed on the vehicle. The power line has a third end and a fourth end, wherein the third end is connected with the body and the fourth end is suitable for plugging into an external socket. The second coil is disposed on the body and electronically connected with the power line. The first magnetic element is disposed in the body and adjacent to the first coil. The electronic device has a second coil, wherein when the electronic device is placed on the body of the wireless charging holder, the first magnetic element magnetically attaches the electronic device to position the electronic device on the body, and a portion of the first coil overlaps a portion of the second coil.

In an embodiment of the assembly of an electronic device and a wireless charging holder of the invention, the first coil is disposed in the body or disposed on the surface of the body.

In an embodiment of the assembly of an electronic device and a wireless charging holder of the invention, the fixing element is a suction attachment or a suction cup.

In an embodiment of the assembly of an electronic device and a wireless charging holder of the invention, the first magnetic element is at the center of the first coil, at four sides on the outside of the first coil, at four sides on the inside of the first coil, or a combination thereof.

In an embodiment of the assembly of an electronic device and a wireless charging holder of the invention, the electronic device further includes a second magnetic element to be magnetically attached with the first magnetic element, wherein the first magnetic element and the second magnetic element are an assembly of a magnet and an element that can be magnetically attached by a magnet. The first magnetic element and the second magnetic element are arranged in pairs, the first coil is between the pair of first magnetic elements, and the second coil is between the pair of second magnetic elements. Alternatively, the first magnetic element is a magnet, the second magnetic element is a metal shield case, and the magnet positions the electronic device on the body by magnetically attaching the metal shield case.

Based on the above, in the wireless charging holder and the assembly of an electronic device and a wireless charging holder of the invention, since the first magnetic element is disposed in the wireless charging holder, the electronic device can be positioned on the body via a method of magnetically attaching. Moreover, the wireless charging holder does not readily cause any scratching to the case of the electronic device. Moreover, the wireless charging holder further has the function of wireless charging, which is convenient for charging the electronic device.

To make the above features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a conventional holder.

FIG. 2 is a schematic diagram of a wireless charging holder of an embodiment of the invention.

FIG. 3 is a schematic diagram of an electronic device.

FIG. 4 is a schematic diagram of an electronic device used for assembling with a wireless charging holder.

FIG. 5 is a schematic cross-sectional diagram of a body and a first coil.

FIG. 6 is a schematic cross-sectional diagram of another implement of the body and the first coil.

FIG. 7 is a schematic diagram of a first magnetic element at the center of the first coil.

FIG. 8 is a schematic diagram of another implement of the relative positions of the first magnetic element and the first coil.

FIG. 9 is a schematic diagram of a second magnetic element as a metal shield case.

FIG. 10 is a schematic diagram of the first magnetic element and the second magnetic element arranged in pairs in the assembly of the electronic device and the wireless charging holder.

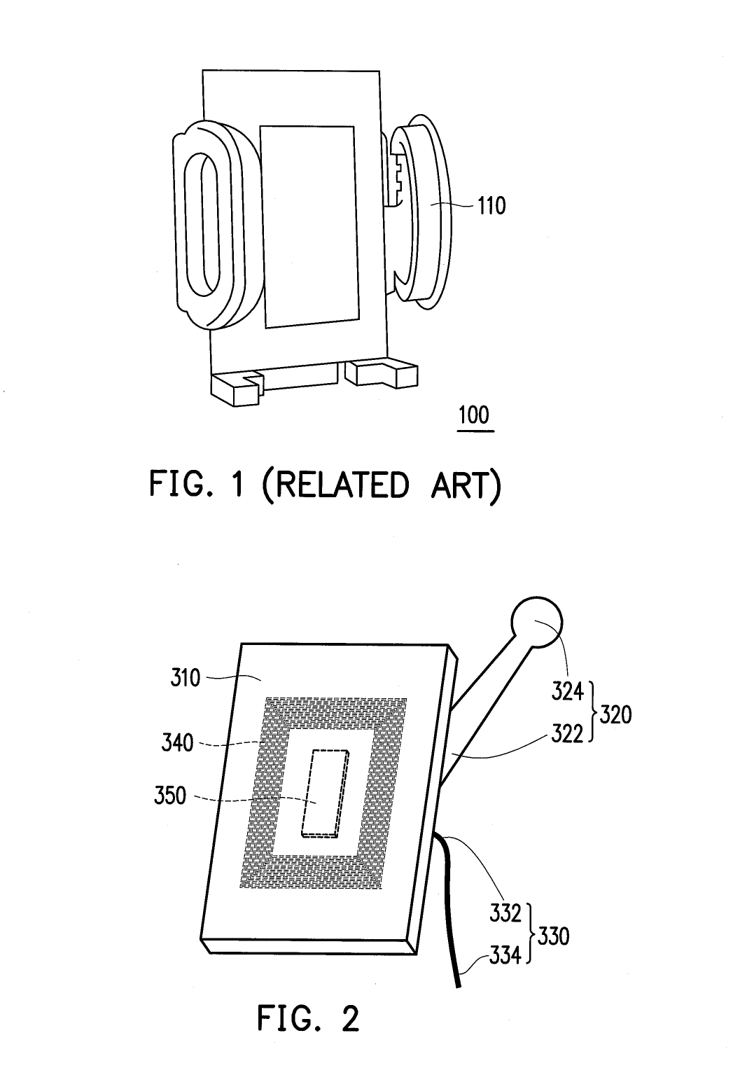

### DESCRIPTION OF THE EMBODIMENTS

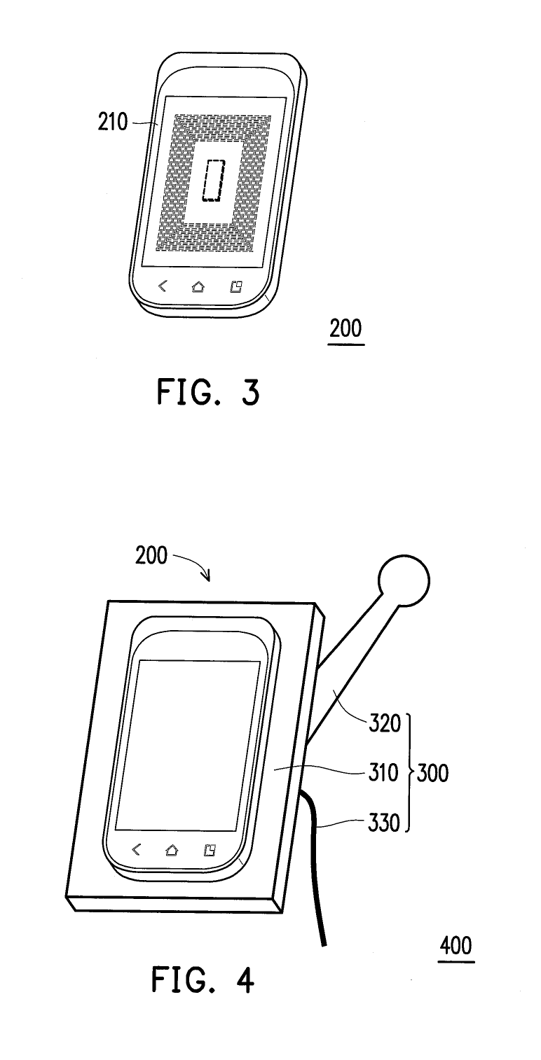

FIG. 2 is a schematic diagram of a wireless charging holder of an embodiment of the invention; FIG. 3 is a schematic diagram of an electronic device; and FIG. 4 is a schematic diagram of an electronic device for assembling with a wireless charging holder. Referring to FIG. 2, FIG. 3, and FIG. 4 at the same time, in an assembly 400 of an electronic device and a wireless charging holder of the present embodiment, an electronic device 200 can be, for instance, a mobile phone, a smart phone, a satellite navigator, or a mobile television. A wireless charging holder 300 is suitable for being installed on a vehicle and the electronic device 200 is suitable for being disposed on the wireless charging holder 300 to allow the user to view or use the electronic device 200 when traveling in a vehicle.

Based on the above, the wireless charging holder 300 includes a body 310, a fixing element 320, a power line 330, a first coil 340, and a first magnetic element 350. The body 310 is suitable for holding the electronic device 200, and the fixing element 320 is, for instance, a suction attachment or a suction cup. The fixing element 320 has a first end 322 and a second end 324, wherein the first end 322 is connected with the body 310 and the second end 324 can have a suction cup to be fixed on the vehicle such as on the glass. The power line 330 has a third end 332 and a fourth end 334, wherein the third end 332 is connected with the body 310 and the fourth end 334 is suitable for being plugged into an external socket. The first coil 340 is disposed on the body 310 and electronically connected with the power line 330, and power supplied by the external socket is transferred thorough the power line to the first coil 340 which is electronically connected with the third end 332. The first magnetic element 350 is disposed in the body 310 and adjacent to the first coil 340. The electronic device 200 has a second coil 210, when the electronic device 200 is placed on the body 310 of the wireless charging holder 300; the first magnetic element 350 magnetically attaches the electronic device 200 to position the electronic device 200 on the body 310. Moreover, a portion of the first coil 340 at least overlaps a portion of the second coil 210 such that after a power is input, magnetic field is generated by the first coil 340 and then current is induced to flow in the second coil 210 due to induction by the magnetic field and so as to charge the electronic device 200.

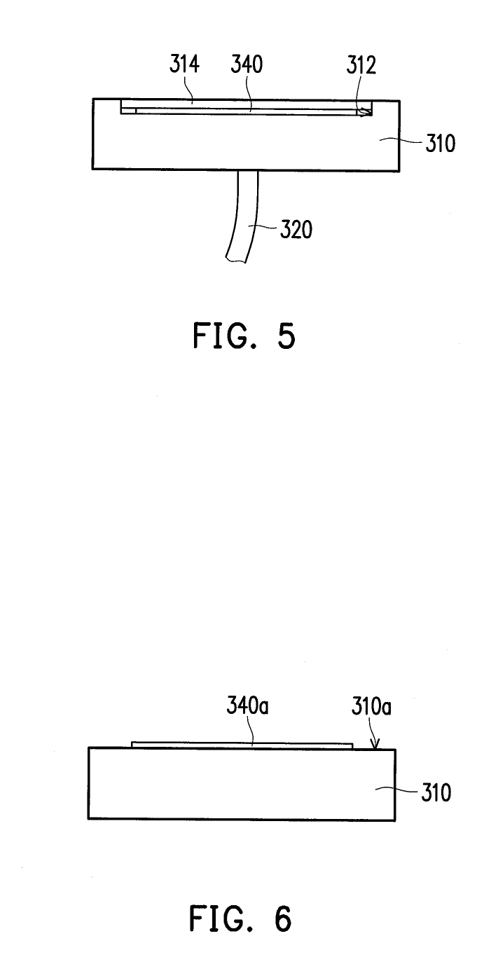

In the present embodiment, the body 310 can have a notch 312, the first coil 340 is disposed in the notch 312 of the body 310, and a cover body 314 having the same material as the body 310 further covers on the first coil 340, such that the appearance of the body 310 looks more complete as shown in the schematic cross-sectional diagram of the body 310 and the first coil 340 of FIG. 5. Moreover, in another implement, the first coil 340a can also be directly disposed on a surface 310a of the body 310 as shown in FIG. 6. That is, the first coil 340a is disposed outside of the body 310.

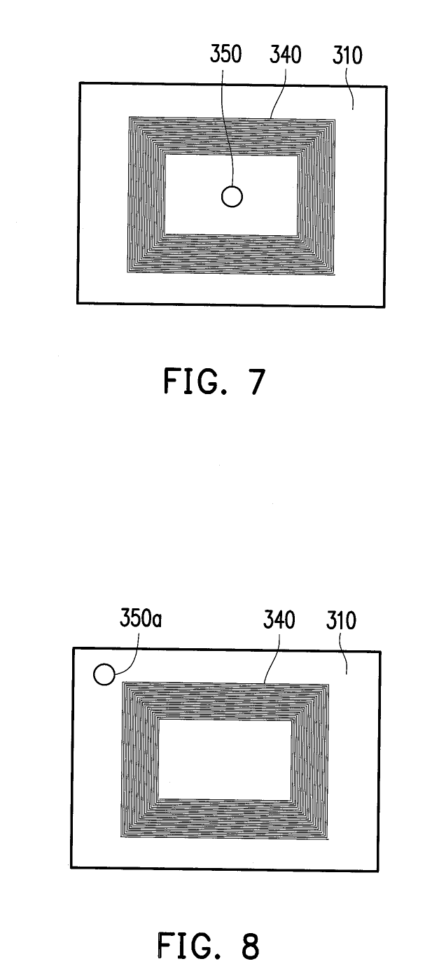

Moreover, the first magnetic element 350 of the present embodiment is disposed adjacent to the first coil 340 and the first magnetic element 350 is at the center of the first coil 340 as shown in FIG. 7. However, the first magnetic element 350 is not limited to be at the center of the first coil 340. In other implements, the first magnetic element 350a can also be disposed anywhere in the periphery adjacent to the first coil 340 as shown in FIG. 8. Disposing the first magnetic element 350a adjacent to the first coil 340 refers to when the electronic device 200 is disposed on the body 310, a portion of the first coil 340 at the body 310 needs to be overlapped with a portion of the second coil 210 at the electronic device 200 to achieve the effect of inducing current.

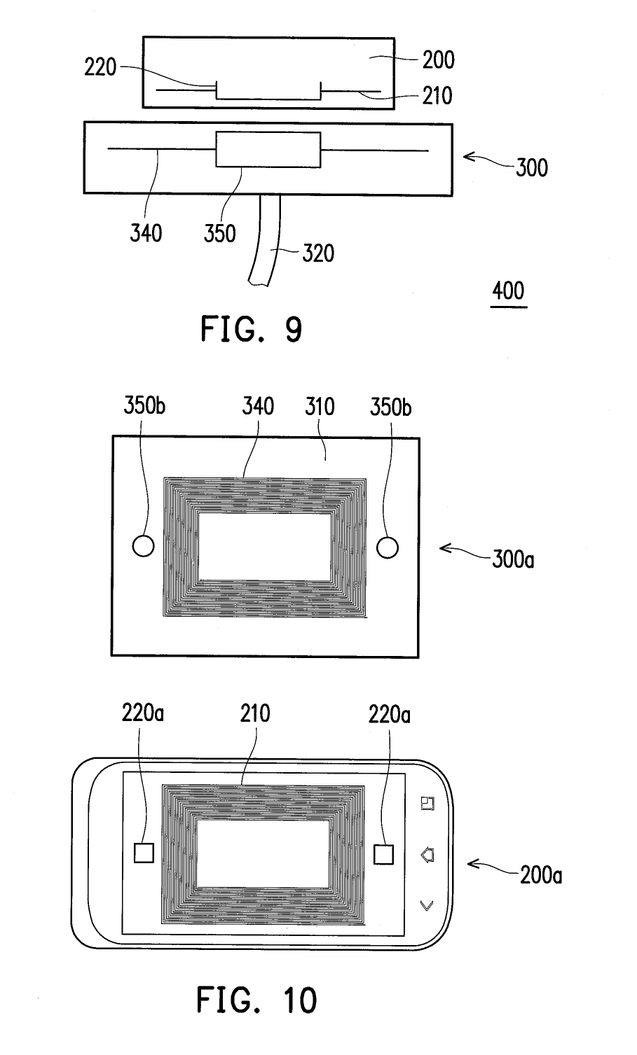

Based on the above, to achieve the effect of positioning the electronic device 200 on the body 310, the first magnetic element 350 can be a magnet, wherein the magnet can position the electronic device 200 on the body 310 by magnetically attaching the second magnetic element 220 inherently present in the electronic device 200 that can be magnetically attached by a magnet, as shown in FIG. 9. The second magnetic element 220 is, for instance, a metal shield case or other magnetic elements that can be magnetically attached by a magnet but the function of which is not affected by the magnet.

Moreover, in other implements, the second magnetic element 220 can also be additionally disposed in the electronic device 200 to be magnetically attached with the first magnetic element 350. Here, the first magnetic element 350 and the second magnetic element 220 are an assembly of a magnet and an element that can be magnetically attached by a magnet. For instance, the first magnetic element 350 and the second magnetic element 220 can together be a magnet, the first magnetic element 350 is a magnet, and the second magnetic element 220 is an element that can be magnetically attached by a magnet such as a metal element. Alternatively, the first magnetic element 350 is an element that can be magnetically attached by a magnet such as a metal element and the second magnetic element 220 is a magnet. The selection thereof is based on requirement. Of course, as long as the design of each of the circuit and the structure is appropriate, the invention does not exclude the possibility of using an electromagnet for the first magnetic element 350 and the second magnetic element 220.

Moreover, in the implement of FIG. 10, the first magnetic element 350b and the second magnetic element 220a can further be arranged in pairs, wherein the first coil 340 is between the pair of first magnetic elements 350b and the second coil 210 is between the pair of second magnetic elements 220a. Through such disposition, better positioning effect can be achieved when the electronic device 200a is disposed on the body 310 of the wireless charging holder 300a. Moreover, the region of each of the first coil 340 and the second coil 210 are almost completely overlapped, thereby achieving better charging efficiency.

Based on the above, in the wireless charging holder and the assembly of a wireless charging holder and an electronic device using the wireless charging holder, since the first magnetic element is disposed in the wireless charging holder, the electronic device can be positioned on the body via a method of magnetically attaching. Moreover, since the body is only in contact with the back cover of the electronic device and is positioned via a method of magnetically attaching, other positioning structures such as ears do not need to be disposed on the body, and therefore scratches do not result as readily on the case of the electronic device. Moreover, a coil for inducing current is disposed in the electronic device, and when the power line of the wireless charging holder is plugged into an external socket, the coil in the body of the wireless charging holder electronically connected with the power line generates a magnetic field, causing the coil in the electronic device to induce current and thereby charge the electronic device. In short, the wireless charging holder not only has the advantage of a simple structure, but also has the functions of positioning and charging at the same time.

Although the invention has been described with reference to the above embodiments, it will be apparent to one of the ordinary skill in the art that modifications to the described embodiments may be made without departing from the spirit of the invention. Accordingly, the scope of the invention is defined by the attached claims not by the above detailed descriptions.

What is claimed is:

1. A wireless charging holder suitable for being installed on a vehicle and an electronic device suitable for being placed on the wireless charging holder for charging, comprising:
a body suitable for holding the electronic device;
a fixing element having a first end and a second end, wherein the first end is connected with the body and the second end is fixed on the vehicle;
a power line having a third end and a fourth end, wherein the third end is connected with the body and the fourth end is suitable for being plugged into an external socket;
a coil disposed on the body and electronically connected with the power line; and
a first magnetic element disposed in the body and adjacent to the coil to magnetically attach the electronic device.

2. The wireless charging holder of claim 1, wherein the coil is disposed in the body or disposed on a surface of the body.

3. The wireless charging holder of claim 1, wherein the fixing element is a suction attachment or a suction cup.

4. The wireless charging holder of claim 1, wherein the first magnetic element is at a center of the coil, at four sides on an inside of the coil, at four sides on an outside of the coil, or a combination thereof.

5. An assembly of an electronic device and a wireless charging holder, wherein the wireless charging holder of the assembly of an electronic device and a wireless charging holder is suitable for being installed on a vehicle, the assembly of an electronic device and a wireless charging holder comprising:
the wireless charging holder, comprising:
a body suitable for holding the electronic device;
a fixing element having a first end and a second end, wherein the first end is connected with the body and the second end is fixed on the vehicle;
a power line having a third end and a fourth end, wherein the third end is connected with the body and the fourth end is suitable for being plugged into an external socket;
a first coil disposed on the body and electronically connected with the power line;
a first magnetic element disposed in the body and adjacent to the first coil; and
an electronic device having a second coil,
wherein when the electronic device is placed on the body of the wireless charging holder, the first magnetic element magnetically attaches the electronic device to position the electronic device on the body, and a portion of the first coil at least overlaps a portion of the second coil.

6. The assembly of an electronic device and a wireless charging holder of claim 5, wherein the first coil is disposed in the body or disposed on a surface of the body.

7. The assembly of an electronic device and a wireless charging holder of claim 5, wherein the fixing element is a suction attachment or a suction cup.

8. The assembly of an electronic device and a wireless charging holder of claim 5, wherein the first magnetic element is at a center of the first coil, at four sides on an outside of the first coil, at four sides on an inside of the first coil, or a combination thereof.

9. The assembly of an electronic device and a wireless charging holder of claim 5, wherein the electronic device further comprises a second magnetic element magnetically attached with the first magnetic element.

10. The assembly of an electronic device and a wireless charging holder of claim 9, wherein the first magnetic element and the second magnetic element are an assembly of a magnet and an element that can be magnetically attached by the magnet.

11. The assembly of an electronic device and a wireless charging holder of claim 10, wherein the first magnetic element and the second magnetic element are arranged in pairs, the first coil is between the pair of first magnetic elements, and the second coil is between the pair of second magnetic elements.

12. The assembly of an electronic device and a wireless charging holder of claim 9, wherein the first magnetic element is a magnet, the second magnetic element is a metal shield case, and the magnet positions the electronic device on the body by magnetically attaching the metal shield case.
